(19) United States
(12) Patent Application Publication
(10) Pub. No.: US 2025/0282954 A1
(43) Pub. Date: Sep. 11, 2025

(54) SCALABLE TEMPERATURE ADAPTIVE RADIATIVE COATING WITH OPTIMIZED SOLAR ABSORPTION

(71) Applicant: THE REGENTS OF THE UNIVERSITY OF CALIFORNIA, Oakland, CA (US)

(72) Inventors: Junqiao Wu, Kensington, CA (US); Jiachen Li, Berkeley, CA (US); Kaichen Dong, Shenzhen (CN)

(73) Assignee: THE REGENTS OF THE UNIVERSITY OF CALIFORNIA, Oakland, CA (US)

(21) Appl. No.: 19/204,413

(22) Filed: May 9, 2025

Related U.S. Application Data
(63) Continuation of application No. PCT/US2023/082702, filed on Dec. 6, 2023.
(60) Provisional application No. 63/386,270, filed on Dec. 6, 2022.

(51) Int. Cl. C09D 1/00; C09D 7/61; C09D 123/06

(52) U.S. Cl. CPC C09D 1/00; C09D 7/61; C09D 123/06

(57) ABSTRACT

A roll-to-roll printed, mechanically flexible, temperature-adaptive radiative coating for thermal regulation of surfaces and fabrication methods are provided. The coating can include a thick metal layer, or a substrate and a metal layer deposited on the substrate, an array of tungsten-doped vanadium dioxide (WₓV₁₋ₓO₂) blocks on the metal layer, and a mid-infrared transparent dielectric layer over the blocks. This base coating may also have a layer of one or more colored pigments on the top surface of the base dielectric layer that is covered by a second IR transparent dielectric layer. Thermal emittance of the coating switches automatically as a function of ambient temperature in relation to the metal-insulator phase transition temperature (T_{MIT}) of the WₓV₁₋ₓO₂ blocks in the array.

### CROSS-REFERENCE TO RELATED APPLICATIONS

This application claims priority to, and is a 35 U.S.C. § 111 (a) continuation of, PCT international application number PCT/US2023/082702 filed on Dec. 6, 2023, incorporated herein by reference in its entirety, which claims priority to, and the benefit of, U.S. provisional patent application Ser. No. 63/386,270 filed on Dec. 6, 2022, incorporated herein by reference in its entirety. Priority is claimed to each of the foregoing applications.

The above-referenced PCT international application was published as PCT International Publication No. WO 2024/123893 A1 on Jun. 13, 2024, which publication is incorporated herein by reference in its entirety.

### STATEMENT REGARDING FEDERALLY SPONSORED RESEARCH OR DEVELOPMENT

This invention was made with Government support under grant number 1953803, awarded by the National Science Foundation. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

This technology pertains generally to methods and compositions for energy efficient coatings and roofing materials and more particularly to methods for scalable temperature-adaptive radiative coating (STARC) materials that optimize solar absorption and maximize infrared thermal emission.

### 1. Technical Field

For decades, researchers have been developing cool roof materials to cool buildings and save energy for air conditioning. These roofing materials have been engineered to have minimized solar absorption and maximized infrared thermal emission. Thus, the building can be effectively cooled as heat is efficiently emitted to outer space, which is a natural heat sink. However, those conventional cool roof materials also strongly emit heat even on cold nights and in wintertime. In these cases, the resultant overcooling will exacerbate the space heating cost and may outweigh the energy-saving benefit in hot daytime temperatures during summertime.

### 2. Background Discussion

Recently, a new roof material called temperature adaptive radiative coating (TARC) was developed that is aimed at eliminating this overcooling problem. The temperature-adaptive radiative coating saves energy by adapting its thermal emittance to ambient temperatures based on the metal-insulator transition of vanadium oxide. When the ambient temperature is higher than a preset transition temperature, the TARC coating delivers a high thermal emittance, and the roof (hence the building) will be cooled. In the other case, when the ambient temperature is lower than the preset temperature, the TARC switches to a low-emittance state to minimize the heat loss through the roof. The TARC materials are projected to outperform all existing roof materials in most climate areas, especially those with significant seasonal or daily temperature variations. However, there are many hurdles to realistic roof applications with TARC materials. Because TARC has a complicated structure that requires high-cost fabrication techniques such as photolithography, pulsed laser deposition, and XeF₂ etching, the production of TARC materials is not scalable and is done at a high cost. Moreover, the lifetime of TARC is limited by the materials used and the overall structure.

Accordingly, there is a need for the development of new materials that are easy to fabricate, scalable and relatively inexpensive.

### BRIEF SUMMARY

Methods and coating compositions are provided for controllable temperature-adaptive radiative cooling illustrated with a roll-to-roll printed, mechanically flexible, temperature-adaptive radiative coating for thermal regulation of surfaces. The materials are referred herein as a scalable temperature-adaptive radiative coating (STARC). The STARC material is intended to address problems associated with prior technologies such as temperature adaptive radiative coating (TARC). The STARC coating provides the same thermal emittance switching capability as TARC but with different structure and fabrication procedures. One aspect of STARC is that it can be produced with a high-throughput roll-to-roll method with low-cost materials.

In one embodiment of the STARC composition, the key phase-transition material (vanadium oxide) is encapsulated and protected from water and air. Consequently, the STARC composition has a much longer lifetime compared to TARC compositions. Additionally, extra structure and materials can be introduced into STARC coatings to tune the color for aesthetic requirements and solar absorption. With adjustable solar absorption, the STARC coatings can be customized to suit different climates.

In one preferred embodiment, a scalable temperature-adaptive radiative coating is provided with a metal layer, an array of tungsten-doped vanadium dioxide (WₓV₁₋ₓO₂) blocks deposited on the metal layer; and a mid-infrared transparent dielectric layer deposited on the metal layer and encapsulating the blocks. The thermal emittance of the coating switches automatically as a function of ambient temperature in relation to the metal-insulator phase transition temperature (T_{MIT}) of the WₓV₁₋ₓO₂ in the array and the phase-transition temperature is tunable by varying the tungsten composition x of the blocks.

In another embodiment, the coating also includes a layer of infrared-transparent pigments or a sub-skin-depth metal layer over the dielectric layer that are sealed by a second dielectric layer. Solar absorption of the coating is controllable by varying the pigment species and coverage or by varying species and thickness of the sub-skin-depth metal layer.

Accordingly, an aspect of the STARC technology is to provide for year-round energy saving on temperature regulation in buildings. For example, the STARC can be used as roof or wall coating to save the energy consumption of HVAC systems in buildings. The STARC can also be used for passive thermal regulation in systems that can have surfaces facing the sky, such as tents, vehicles, satellites, spacesuits, greenhouses, and electronics.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic diagram of the working principle of STARC material illustrated as a roof coating, where solar absorptance is temperature-independent but optimized to local climate, and thermal emittance switches automatically with changes in ambient temperature.

FIG. 2 is a cross-sectional view of STARC structure where T<T_{MIT} and IR emissions are suppressed.

FIG. 3 is a cross-sectional view of STARC structure where T>T_{MIT} and

IR emissions are enhanced.

FIG. 4 is a perspective view of a STARC structure array according to one embodiment of the technology.

FIG. 5 is a cross-sectional view of an alternative STARC structure with a layer of IR transparent pigments producing a colored STARC structure with a color depending on the selected pigment.

FIG. 6 is a plot of spectral emittance of a STARC structure shown in FIG. 2 or FIG. 3.

FIG. 7 is a plot of integrated sky-window emittance vs. temperature of a STARC coating structure.

FIG. 8 is a plot of spectral absorptance of pigmented STARC structures in the solar wavelength range of the embodiment shown in FIG. 5.

FIG. 9 is a schematic illustration of the manufacturing process steps for fabricating a STARC structure according to one embodiment of the technology.

FIG. 10 is a schematic illustration of the manufacturing process steps for fabricating a reusable imprint template for molding polyethylene films according to one embodiment of the technology.

FIG. 11 is a graph showing the indoor temperature of model houses with different roof materials (STARC and two reference commercial paints) with two different temperature time periods.

### DETAILED DESCRIPTION

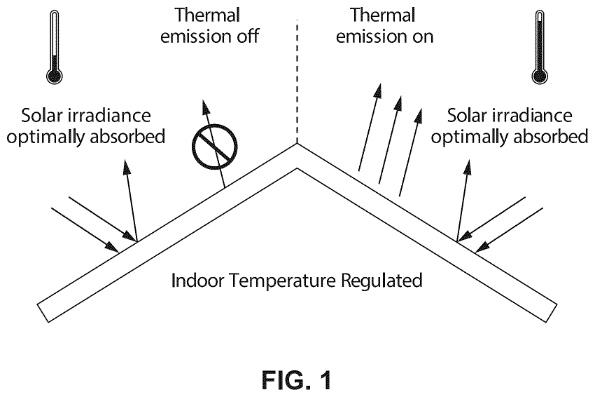

Referring more specifically to the drawings, for illustrative purposes, compositions, constructs and methods for thermal regulation of surfaces using a roll-to-roll printed, mechanically flexible, scalable temperature-adaptive radiative coating (STARC) are generally shown. Several embodiments of the technology are described generally in FIG. 1 to FIG. 11 to illustrate the characteristics and functionality of the compositions, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, the working principle of STARC is schematically illustrated as a roof coating, where solar absorptance is temperature-independent but optimized to local climate, and thermal emittance switches automatically with a change in ambient temperature. According to simulations, a temperature-adaptive radiative coating that has a static solar absorptance (0.25) and a switchable thermal emittance (0.2 to 0.9) with a switching temperature of ˜22° C. has the potential to save 10% of electric consumption in an average U.S. house.

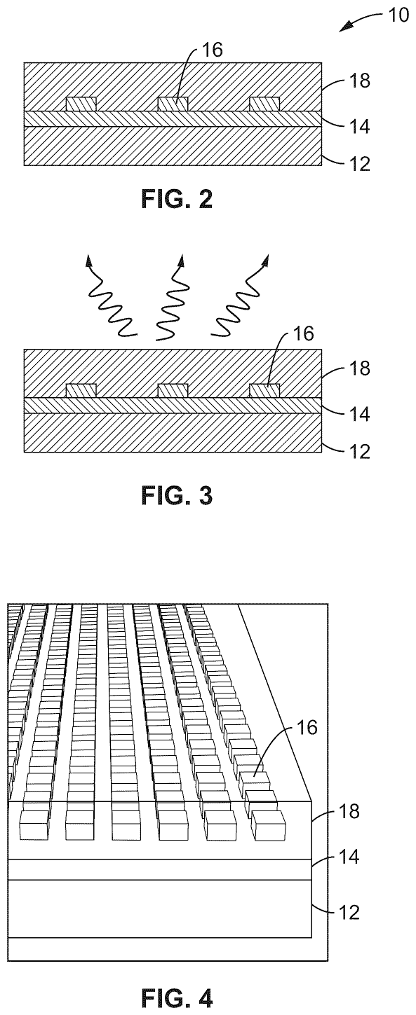

In one embodiment, shown in FIG. 2 to FIG. 4, the STARC structure includes a substrate 12, a metal layer 14 deposited on the substrate 12, an array of tungsten-doped vanadium dioxide (WₓV₁₋ₓO₂) blocks 16, and a mid-infrared transparent dielectric layer 18. In an alternative embodiment, the metal layer 16 can be sufficiently thick to function as a substrate rather than having a separate substrate 12 and metal layer 14.

As shown in FIG. 2 where T<T_{MIT} and IR emissions are suppressed. When T>T_{MIT} the IR emissions are enhanced as illustrated schematically by the arrows in FIG. 3. FIG. 4 illustrates a typical STARC array. The emittance switching ability of the STARC structure is based on the metal-insulator transition of WₓV₁₋ₓO₂, whose phase-transition temperature can be tuned by the tungsten composition x to suit different applications. For general household applications, x can be set as 2% so the corresponding phase transition temperature (T_{MIT}) is around 22° C., for example.

At temperatures lower than T_{MIT}, WₓV₁₋ₓO₂ is in the insulator phase and is almost transparent to infrared radiation in the approximately 8 μm to 13 μm sky spectral window. Thus, the whole material functions as a metal mirror with very low infrared absorptance.

When the temperature is higher than T_{MIT}, WₓV₁₋ₓO₂ switches to the metal phase, and the infrared absorption of the STARC structure is strongly amplified by the Fabry-Perot resonance in the dielectric layer as well as the photonic resonance between adjacent WₓV₁₋ₓO₂ blocks. According to Kirchhoff's law of radiation, the emittance is equal to the absorptance of a system at the same wavelength. Therefore, STARC structure acts as a high-emittance radiative cooler coating at (and only at) high temperatures, while retaining heat under the surface at low temperatures. Note that the STARC structure does not have any moving parts, and that the transition between the low-emission state and high-emission state is completely passive (i.e. requiring no energy input and user intervention).

The STARC structure also features an adjustable solar absorptance, which is an additional crucial factor affecting the annual energy saving by the temperature-adaptive radiative materials. For example, in cities with colder temperatures throughout the year, a higher solar absorption of the roof or wall can increase the energy intake from sunlight and save more energy from space heating. While in cities with tropical climates, low solar absorption is desired since the major energy consumption in buildings is for air conditioning.

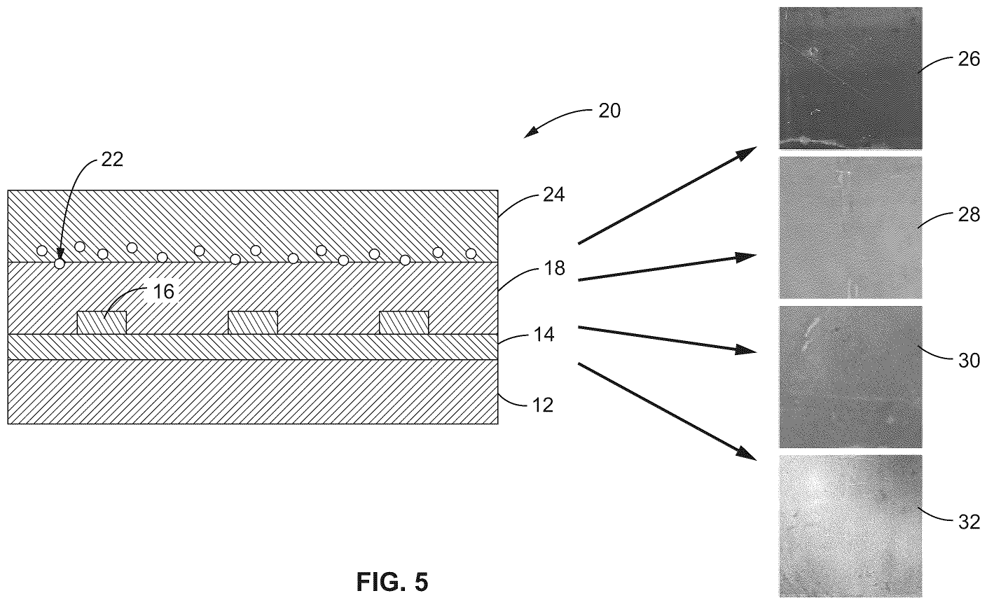

In the alternative embodiment shown in FIG. 5, the STARC structure has a base substrate 12, preferably composed of PET with a metal layer 14. The metal layer 14 has a plurality of tungsten doped-vanadium oxide blocks 16 that is overlaid with a mid-infrared transparent dielectric layer 18 as shown in FIG. 2. In this embodiment, the dielectric layer 18 has one or more layers of at least one IR-transparent pigment 22. The pigment layer 22 is covered with an IR transparent dielectric layer 24. As illustrated in FIG. 5, the IR-transparent pigment layer 22 may have one of a variety of pigments such as Prussian blue 26, ZnSe pigments 28, Fe₂O₃ pigments 30 and BaF₂ pigments 32. Other pigments and combinations of pigments can be used as well.

This embodiment of the STARC structure 20 can be customized and tuned with color pigments. The structure can be optimized in its solar absorptance by adding an extra layer of infrared-transparent pigments 22 sealed with a dielectric layer 24. A wide modulation in the range of solar adsorption to fit different local climates can be achieved with the selection of components in the combination of different species and different coverage of pigments used.

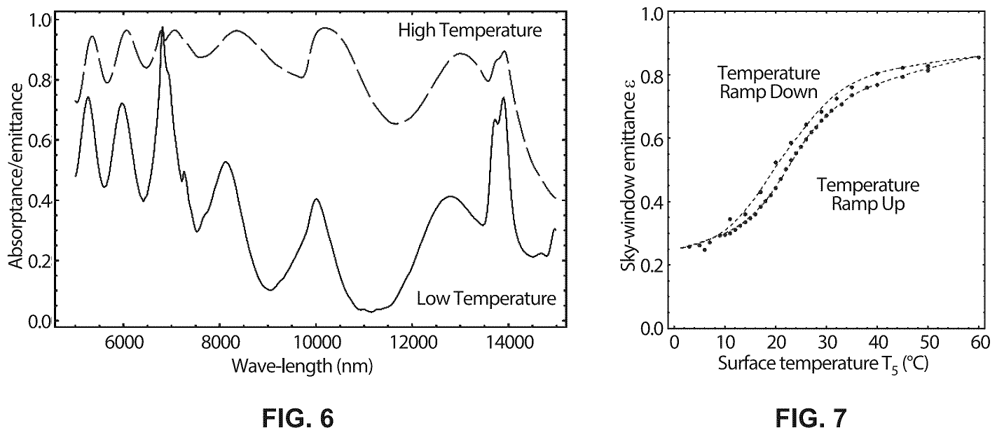

The spectral reflectance r (λ, T) of STARC structure 20 can be characterized by spectrometer measurements. Then the thermal emittance and solar absorptance can be calculated as 1−r(λ, T) in the mid-IR and UV to visual range, respectively. During the measurements, the temperature of STARC samples can be controlled by a closed-loop thermal stage connected to a temperature controller. For example, FIG. 6 shows the spectral absorptance/emittance ε(λ, T) of STARC structures 20 measured by an FT-IR spectrometer. It can be seen that as the temperature increases, the emittance of the STARC structure significantly rises from a low value to a high value. To quantify the emittance change, the sky-window emittance of STARC is calculated by the equation:

$${ε}_{sky} ( T ) = \frac{\int ε ( λ , T ) B ( λ , T ) d λ}{\int B ( λ , T ) d λ} ,$$

where B (λ, T) is the spectral intensity of blackbody radiation at temperature T, and the integrations are in the range of about 8 μm to about 13 μm, which is the atmospheric window.

As shown in FIG. 7, the sky-window emittance of STARC can switch from 0.25 to 0.85 within the typical roof temperature range. More measurements on colored STARC verified that the additional layer of infrared-transparent pigments does not interfere with the values and switchability of emittance in both the low temperature and high temperature states.

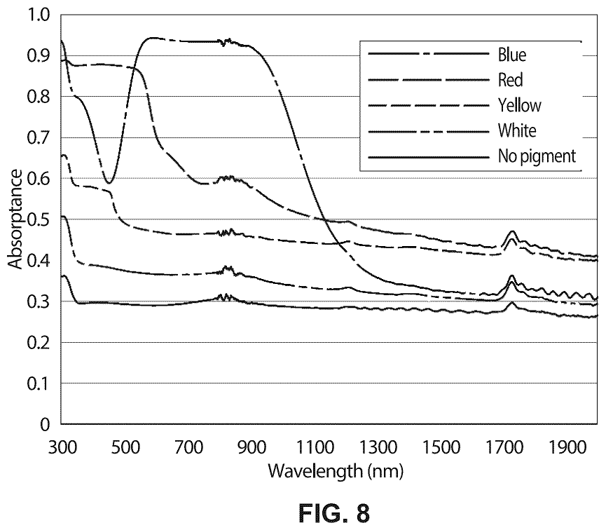

Furthermore, the spectral absorptance in solar range can also be measured for non-colored (FIG. 2) and colored versions (FIG. 5) of the STARC structures as illustrated in FIG. 8. The spectra plotted in FIG. 8 shows that the solar absorptance of the STARC structures can be tuned over a wide range, which allows further optimization of the year-round energy saving for different climates. Temperature-dependent measurements proved that the solar absorptance of both the non-colored and colored versions of STARC structures stay unchanged across the phase transition.

Another major advantage of STARC structures is the scalability of compositions and manufacturing processes. With a roll-to-roll fabrication system, STARC structures can be continuously printed at a low cost and a high throughput, and without an upper limit in size. Moreover, since WₓV₁₋ₓO₂ and the pigments are encapsulated inside the polyethylene (PE) film, degradation of these materials can be drastically suppressed so that sustainability is ensured. Thus, STARC structures have much longer lifetimes compared to other WₓV₁₋ₓO₂-based temperature-adaptive radiative structures.

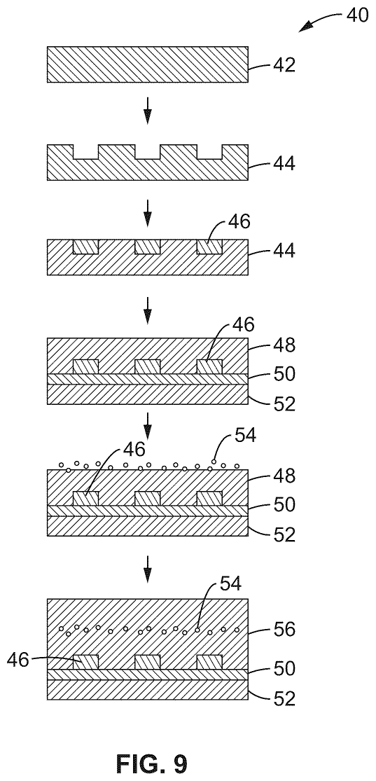

Referring now to FIG. 9, one embodiment of a method 40 for fabricating STARC structures is shown schematically. Initially, a film 42 of polyethylene is imprinted with a metal template to produce an imprinted film 44. The reusable metal template is preferably a metal sheet or drum with an outer surface with a periodic array of micron-sized pillars that can be used in a conventional heated roller system. An array of holes or other shapes of the same dimensions will be imprinted on the surface of the PE film layer 44.

The patterned holes in the film 44 are filled with micro-particles 46 of WₓV₁₋ₓO₂ to produce a filled imprinted film 48. In one embodiment, the micro-particles 46 of WₓV₁₋ₓO₂ are spread onto the patterned PE film 44 surface by spraying with a suspension of particles and isopropyl alcohol. Mechanical pressure can be applied to the WₓV₁₋ₓO₂ particles to improve the filling of the holes. Excessive WₓV₁₋ₓO₂ particles may be wiped off of the surface to produce a PE film 48 embedded with a planar array of WₓV₁₋ₓO₂ blocks.

The STARC structure is produced by laminating the embedded PE film 48 with a metal layer 50 and a substrate film layer 52. In one embodiment, the STARC structure is formed by laminating a metalized polyester layer to the patterned side of the PE film by running the laminated structure another time through a heated roller system.

To modify the color and solar absorption of STARC, additional steps can be added to the fabrication process of STARC structures. Pigments that are transparent in the sky window wavelength range are sprayed onto the STARC surface. Then the pigments are sealed by laminating a smooth PE film on the top. Preferred pigments include Prussian Blue (Blue), BaF₂ (White), ZnSe (Yellow), and Fe₂O₃ (red) as the pigments. More colors can be achieved with different combinations of these basic pigments.

The top surface of the filled polyethylene layer 44 of the laminated structure 48 may optionally be covered with a layer 54 of selected infrared transparent pigments or combinations of pigments. The pigment layer 54 can also be replaced with a thin metal layer to increase the solar reflection in one embodiment. The metal layer should be thinner than the skin-depth of mid-IR light but thicker than that of solar light. This pigment layer 54 is then coupled with a second PE layer 56 by lamination, for example, to produce the final STARC structure.

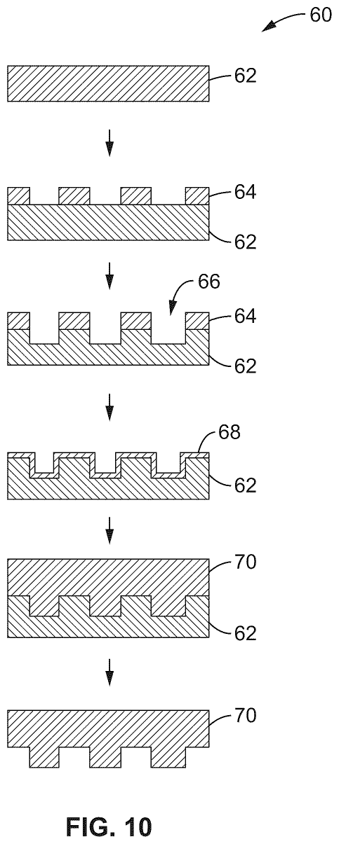

The patterning for imprinting films of polyethylene or similar materials is preferably performed with a reusable template. In one embodiment the process to produce the reusable metal template a patterned Si substrate is fabricated by lithography and etching. As illustrated in FIG. 10, a silicon slab 62 is provided and a patterned photoresist layer 64 is applied to the surface. The silicon slab 62 with the patterned resist 64 is then etched to pattern 66 the silicon using conventional etching techniques.

A conductive metal layer 68 is sputtered or otherwise applied on the patterned Si surface 62. Then a metal layer 70 is greater than approximately 2 μm thickness can be deposited on the sputtered metal layer 68 by electroplating.

Then the Si substrate 62 is preferably removed by KOH etching, and the remaining patterned metal layer 70 is the desired reusable template that can be used for imprinting PE films.

The technology described herein may be better understood with reference to the accompanying examples, which are intended for purposes of illustration only and should not be construed as in any sense limiting the scope of the technology described herein as defined in the claims appended hereto.

### Example 1

To illustrate the functionalities and capabilities of the STARC structures, an outdoor temperature regulation experiment was conducted to demonstrate the performance of STARC as a smart roof coating. The STARC structure, a dark roof coating product (BEHR #N520 Asphalt Gray), and a cool roof coating product (Henry Enviro-White Extreme Elastomeric Roof Coating) were used as roofs on three model houses. The model houses were 3D-printed with ABS filament and were painted with white (walls) and dark (windows and doors) commercial paints. To simulate the heat exchange of real houses, the thermal conductance per area of the model house was carefully tuned to be close to that of real houses by adjusting the wall and roof thickness of the model houses.

The indoor and roof temperatures of the three model houses were measured by temperature sensors inside of each model house, and the temperature-time series were recorded by a Raspberry Pi. The experiment was performed on a cloudless summer day on a residential house roof in Berkeley, CA and the weather data were retrieved from a weather station near the site of the experiment.

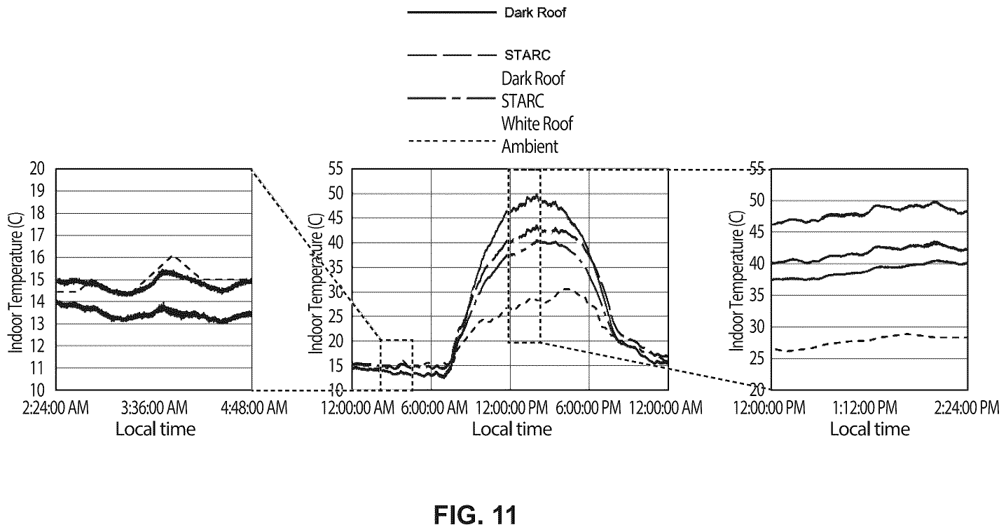

The middle panel of FIG. 11 shows a 24-hour record of the indoor temperature of houses coated with STARC, dark coating, and white cool-roof coating, respectively. The left and right panels are magnified plots of temperature at night and at noon. The temperature-time series shows that during the night, STARC structure can keep the house at a higher indoor temperature, which indicates that STARC switches to a low emittance, heat-retaining state. While at noon with direct sunlight, the STARC coating performs as a cool roof with a solar absorptance slightly higher than that of the commercial white coating. Although the commercial white coating shows an advantage near hot noontime, the STARC coating still outperforms the cool roof coating in terms of year-round energy saving due to its non-stop, all-season thermal regulation.

Additionally, since the phase transition temperature and solar absorption of STARC coatings can be easily adjusted during the manufacturing, STARC can also find temperature-regulation applications in other systems that have surfaces facing the sky, such as tents, vehicles, clothes, space objects and mobile electronics.

From the description herein, it will be appreciated that the present disclosure encompasses multiple implementations of the technology which include, but are not limited to, the following:

A scalable temperature-adaptive radiative coating, comprising: a metal layer; an array of tungsten-doped vanadium dioxide blocks deposited on the metal layer; and a mid-infrared transparent dielectric layer deposited on the metal layer and encapsulating the blocks.

The coating of any preceding or following implementation, further comprising a substrate, and metal layer deposited on the substrate.

The coating of any preceding or following implementation, wherein the metal layer deposited on the substrate has a thickness within the range of about 2 μm to about 20 μm.

The coating of any preceding or following implementation, wherein the substrate comprises a polyester film.

The coating of any preceding or following implementation, wherein a mid-infrared transparent dielectric layer comprises polyethylene.

The coating of any preceding or following implementation, wherein the tungsten-doped vanadium dioxide blocks have the formula WₓV₁₋ₓO₂.

The coating of any preceding or following implementation, wherein thermal emittance of the coating switches automatically as a function of ambient temperature in relation to a metal-insulator phase transition temperature (T_{MIT}) of the tungsten-doped vanadium dioxide blocks (WₓV₁₋ₓO₂) in the array.

The coating of any preceding or following implementation, wherein the phase-transition temperature is tunable by varying the tungsten composition X.

The coating of any preceding or following implementation, wherein at ambient temperatures lower than the T_{MIT}, the WₓV₁₋ₓO₂ in the array is in an insulator phase and exhibits transparency to infrared radiation in an about 8 μm to about 13 μm sky spectral window; and wherein at ambient temperatures higher than the T_{MIT}, the WₓV₁₋ₓO₂ in the array is in the metal phase and emits and infrared radiation.

The coating of any preceding or following implementation, further comprising a layer of infrared-transparent pigments over the dielectric layer, and layer of pigments sealed by a second dielectric layer.

The coating of any preceding or following implementation, where and pigment of and layer of pigment is selected from the group consisting of Prussian blue pigments, ZnSe pigments, Fe₂O₃ pigments and BaF₂ pigments and combinations thereof.

The coating of any preceding or following implementation, wherein solar absorption of the coating is controllable by varying pigment species and coverage of the pigment.

The coating of any preceding or following implementation, further comprising a sub-skin-depth metal layer over the dielectric layer, and sub-skin-depth metal layer sealed by a second dielectric layer.

The coating of any preceding or following implementation, wherein solar absorption of the coating is controllable by varying thickness of the sub-skin-depth metal layer.

A scalable temperature-adaptive radiative coating, comprising: a metal layer; an array of tungsten-doped vanadium dioxide (WₓV₁₋ₓO₂) blocks deposited on the metal layer; a first mid-infrared transparent dielectric layer deposited on the metal layer and encapsulating the blocks; a layer of one or more infrared-transparent pigments or a sub-skin-depth metal layer deposited over the first dielectric layer; and a second mid-infrared transparent dielectric layer deposited over the layer of pigments or sub-skin-depth metal layer, and second dielectric layer sealing and pigment layer or sub-skin-depth metal layer to the first dielectric layer.

The coating of any preceding or following implementation, where and pigment of and layer of pigment is selected from the group consisting of Prussian blue, ZnSe pigments, Fe₂O₃ pigments and BaF₂ pigments and combinations thereof.

The coating of any preceding or following implementation, wherein solar absorption of the coating is controllable by varying pigment species and coverage or by varying species and thickness of the sub-skin-depth metal layer.

The coating of any preceding or following implementation, further comprising a substrate, and metal layer deposited on the substrate.

The coating of any preceding or following implementation, wherein the substrate comprises a polyester film and the mid-infrared transparent dielectric layers comprise polyethylene.

The coating of any preceding or following implementation, wherein thermal emittance of the coating switches automatically as a function of ambient temperature in relation to a metal-insulator phase transition temperature (T_{MIT}) of the WₓV₁₋ₓO₂ in the coating.

The coating of any preceding or following implementation, wherein the phase-transition temperature is tunable by varying the tungsten composition X.

The coating of any preceding or following implementation, wherein at ambient temperatures lower than the T_{MIT}, the WₓV₁₋ₓO₂ in the array is in the insulator phase and exhibits transparency to infrared radiation in the about 8 μm to about 13 μm sky spectral window; and wherein at ambient temperatures higher than the T_{MIT}, the WₓV₁₋ₓO₂ in the array is in the metal phase and emits and infrared radiation.

The coating of any preceding or following implementation, wherein the coating is a component of a roof, wall or other exterior surface of a building or other structure.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A scalable temperature-adaptive radiative coating, comprising:
a metal layer;
an array of tungsten-doped vanadium dioxide blocks deposited on the metal layer; and
a mid-infrared transparent dielectric layer deposited on the metal layer and encapsulating the blocks.

2. The coating of claim 1, further comprising a substrate, said metal layer deposited on the substrate.

3. The coating of claim 2, wherein the metal layer deposited on the substrate has a thickness within the range of about 2 μm to about 20 μm.

4. The coating of claim 2, wherein the substrate comprises a polyester film.

5. The coating of claim 1, wherein a mid-infrared transparent dielectric layer comprises polyethylene.

6. The coating of claim 1, wherein the tungsten-doped vanadium dioxide blocks have the formula WₓV₁₋ₓO₂.

7. The coating of claim 6, wherein thermal emittance of the coating switches automatically as a function of ambient temperature in relation to a metal-insulator phase transition temperature (T_{MIT}) of the tungsten-doped vanadium dioxide blocks (WₓV₁₋ₓO₂) in the array.

8. The coating of claim 7, wherein the phase-transition temperature is tunable by varying the tungsten composition x.

9. The coating of claim 7:
wherein at ambient temperatures lower than the T_{MIT}, the WₓV₁₋ₓO₂ in the array is in an insulator phase and exhibits transparency to infrared radiation in an about 8 μm to about 13 μm sky spectral window; and
wherein at ambient temperatures higher than the T_{MIT}, the WₓV₁₋ₓO₂ in the array is in a metal phase and emits said infrared radiation.

10. The coating of claim 1, further comprising a layer of infrared-transparent pigments over the dielectric layer, said layer of pigments sealed by a second dielectric layer.

11. The coating of claim 10, where said pigment of said layer of pigment is selected from the group consisting of Prussian blue pigments, ZnSe pigments, Fe₂O₃ pigments and BaF₂ pigments and combinations thereof.

12. The coating of claim 10, wherein solar absorption of the coating is controllable by varying pigment species and coverage of the pigment.

13. The coating of claim 10, further comprising a sub-skin-depth metal layer over the dielectric layer, said sub-skin-depth metal layer sealed by a second dielectric layer.

14. The coating of claim 10, wherein solar absorption of the coating is controllable by varying thickness of the sub-skin-depth metal layer.

15. A scalable temperature-adaptive radiative coating, comprising:
a metal layer;
an array of tungsten-doped vanadium dioxide (WₓV₁₋ₓO₂) blocks deposited on the metal layer;
a first mid-infrared transparent dielectric layer deposited on the metal layer and encapsulating the blocks;
a layer of one or more infrared-transparent pigments or a sub-skin-depth metal layer deposited over the first dielectric layer; and
a second mid-infrared transparent dielectric layer deposited over the layer of pigments or sub-skin-depth metal layer, said second dielectric layer sealing said pigment layer or sub-skin-depth metal layer to the first dielectric layer.

16. The coating of claim 15, where said pigment of said layer of pigment is selected from the group consisting of Prussian blue, ZnSe pigments, Fe₂O₃ pigments and BaF₂ pigments and combinations thereof.

17. The coating of claim 15, wherein solar absorption of the coating is controllable by varying pigment species and coverage or by varying species and thickness of the sub-skin-depth metal layer.

18. The coating of claim 15, further comprising a substrate, said metal layer deposited on the substrate.

19. The coating of claim 18, wherein the substrate comprises a polyester film and the mid-infrared transparent dielectric layers comprise polyethylene.

20. The coating of claim 15, wherein thermal emittance of the coating switches automatically as a function of ambient temperature in relation to a metal-insulator phase transition temperature (T_{MIT}) of the WₓV₁₋ₓO₂ in the coating.

21. The coating of claim 20, wherein the phase-transition temperature is tunable by varying the tungsten composition x.

22. The coating of claim 15:
wherein at ambient temperatures lower than the T_{MIT}, the WₓV₁₋ₓO₂ in the array is in the insulator phase and exhibits transparency to infrared radiation in the about 8 μm to about 13 μm sky spectral window; and
wherein at ambient temperatures higher than the T_{MIT}, the WₓV₁₋ₓO₂ in the array is in the metal phase and emits said infrared radiation.
